(19) United States
(12) Patent Application Publication
(10) Pub. No.: US 2026/0368509 A1
(43) Pub. Date: Nov. 19, 2026

(54) SYSTEMS AND METHODS FOR GRAPHICAL PROCESSING UNIT LATENCY-MINIMIZED INFERENCE USING DYNAMIC PRECOMPUTATION AND EVENT MATCHING FOR ACCELERATING REAL-TIME AUTOMATED DECISION EXECUTION

(71) Applicant: Penguin Computing Inc., Fremont, CA (US)

(72) Inventors: Philip Pokorny, Dublin, CA (US); Daniel Stuart, Orlando, FL (US); John Casu, Half Moon Bay, CA (US); Kevin Manalo, Saint Johns, FL (US)

(73) Assignee: Penguin Computing Inc., Fremont, CA (US)

(21) Appl. No.: 19/674,508

(22) Filed: May 12, 2026

Related U.S. Application Data
(60) Provisional application No. 63/805,381, filed on May 14, 2025.

(51) Int. Cl. G06N 3/063; G06N 3/047

(52) U.S. Cl. CPC G06N 3/063; G06N 3/047

(57) ABSTRACT

A system, method, and computer-program product includes detecting a plurality of real-time event signals; generating a plurality of predicted event vectors derived at least from the plurality of real-time event signals; dispatching the predicted event vectors to one or more graphics processing units for parallel inference processing to produce a plurality of precomputed inference output vectors; detecting a receipt of an incoming real-time event signal; transforming the incoming real-time event signal into a real-time event vector; performing a similarity search between the real-time event vector and the plurality of predicted event vectors to identify a most similar predicted event vector; retrieving, from a prediction storage buffer, a precomputed inference output vector corresponding to the most similar predicted event vector; and executing an automated control action based on the retrieved precomputed inference output vector, where retrieving the precomputed inference output vector bypasses performing real-time inference on the incoming real-time event vector.

### CROSS-REFERENCE TO RELATED APPLICATIONS

This application claims the benefit of U.S. Provisional Application No. 63/805,381, filed on May 14, 2025, incorporated in its entirety by this reference.

### TECHNICAL FIELD

This invention relates generally to the computer-automated decisioning field, and more specifically, to new and useful systems and methods for minimizing GPU inference latency via dynamic precomputation and event vector matching to enable low-latency decision-making in the computer-automated decisioning field.

### BACKGROUND

In real-time systems that rely on neural networks for decision-making, achieving sub-millisecond or microsecond-level latency is often critical. Applications such as high-frequency trading, autonomous control systems, and real-time fraud detection demand decisions to be made in tight time windows based on continuously evolving input data. In such environments, even minimal inference delays can result in missed opportunities, degraded performance, or unsafe operation.

Conventional approaches to neural network inference are typically synchronous and reactive. When a new event or input is received, the system executes a forward pass through the network to generate a prediction or action. While modern GPUs provide substantial throughput for batched operations, they are often underutilized in low-latency scenarios where individual events arrive intermittently and must be processed in isolation. This mismatch between GPU optimization for batch processing and the need for fast single-inference execution introduces significant latency bottlenecks.

Additionally, traditional inference pipelines perform neural evaluations only after a real-time event is received. This synchronous approach creates a hard latency floor that is difficult to overcome even with hardware acceleration. It also prevents systems from taking advantage of time intervals between events to perform anticipatory computation or speculative evaluation of likely future inputs.

Accordingly, there is a need for systems and methods that can leverage GPU parallelism to precompute inference outputs for plausible future events before they occur, and to reduce real-time inference latency by matching actual events to pre-evaluated outcomes. Such an approach would enable decision-making systems to effectively “hide” the cost of neural inference and execute downstream actions with near-zero delay upon event arrival. The embodiments of the present application provide technical solutions that address, at least, the needs described above, as well as the deficiencies in the state of the art.

### BRIEF SUMMARY OF THE INVENTIONS

In some embodiments, a computer-implemented method for reducing real-time inference latency via predicted event vector precomputation, comprising: detecting, via a continuous stream of real-time input data, a plurality of real-time event signals; generating a plurality of predicted event vectors derived at least from the plurality of real-time event signals; dispatching the predicted event vectors to one or more graphics processing units (GPUs) for parallel inference processing using a neural network model, thereby producing a plurality of precomputed inference output vectors corresponding to the plurality of predicted event vectors; detecting, via the continuous stream of real-time input data, a receipt of an incoming real-time event signal, wherein the incoming real-time event signal is received after generation of the plurality of precomputed inference output vectors is initiated; transforming the incoming real-time event signal into a real-time event vector; performing a similarity search between the real-time event vector and the plurality of predicted event vectors to identify a most similar predicted event vector of the plurality of predicted event vectors relative to the real-time event vector; executing an automated control action based on a precomputed inference output vector of the plurality generated from the most similar predicted event vector.

In some embodiments, the computer-implemented method may further comprise identifying that the most similar predicted event vector of the plurality of predicted event vectors satisfies a similarity threshold relative to the real-time event vector; and selectively executing the automated control action using the precomputed inference output vector based on the most similar predicted event vector of the plurality of predicted event vectors satisfying the similarity threshold.

In some embodiments, executing the automated control action using the precomputed inference output vector bypasses performing inference on the real-time event vector to generate an inference output vector after the real-time event signal is received, thereby reducing total latency between receiving the precomputed inference output vector and executing the automated control action.

In some embodiments, the computer-implemented method may further comprise : storing, prior to performing the similarity search, the precomputed inference output vectors at a prediction storage buffer comprising a vector-indexed data structure; and retrieving the precomputed inference output vector from the prediction storage buffer based on identifying the most similar predicted event vector to the real-time event vector.

In some embodiments, the computer-implemented method may further comprise removing, from the prediction storage buffer, the plurality of precomputed inference output vectors after identifying the most similar predicted event vector, thereby freeing the prediction storage buffer for storage of subsequently generated predicted event vectors.

In some embodiments, the prediction storage buffer resides in GPU memory or high-throughput system memory.

In some embodiments, the computer-implemented method may further comprise regenerating the plurality of predicted event vectors using the incoming real-time event vector via the one or more GPUs; detecting, via the continuous stream of real-time input data and after initiating regeneration the plurality of precomputed inference output vectors, a second incoming real-time event signal; and transforming the second incoming real-time event signal into a second real-time event vector; performing a similarity search between the second real-time event vector and the regenerated plurality of predicted event vectors.

In some embodiments, the computer-implemented method may further comprise invoking an automated fallback processing path based on each predicted event vector of the regenerated plurality failing to satisfy the predefined similarity threshold.

In some embodiments, invoking the automated fallback processing path comprises: dispatching the second real-time event vector to the one or more GPUs to produce an inference output vector for the second real-time event vector; and executing a second executed control action based on the second real-time event vector.

In some embodiments, initiating the parallel inference processing comprises: performing the parallel inference processing during an idle execution interval between real-time event signals, thereby enabling generation of the plurality of precomputed output vectors prior to arrival of the incoming real-time event signal.

In some embodiments, the plurality of predicted event vectors are dispatched within a tensor structure to a single GPU of the one or more GPUs, and the computer-implemented method further comprises: executing, by the single GPU, a forward-pass evaluation of the neural network model over the plurality of predicted event vectors using single-instruction multiple-data (SIMD) parallelism.

In some embodiments, the plurality of predicted event vectors are generated based at least in part on: a system state current to a time at which the plurality of predicted event vectors are generated; a historical sequence of real-time event signals comprising the plurality of received real-time event signals; a probabilistic model defining a constrained space of predicted event vectors; or any combination thereof.

In some embodiments, generating the plurality of predicted event vectors comprises applying the probabilistic model to the system state and the historical sequence of real-time event signals, wherein applying the probabilistic model comprises: estimating a probability distribution over a set of plausible future system states conditioned on the system state and the historical sequence of real-time event signals; and sampling, based on the probability distribution, a plurality of candidate plausible future system states for encoding into the plurality of predicted event vectors.

In some embodiments, generating the plurality of predicted event vectors comprises: inputting the system state and the historical sequence of real-time event signals into a machine-learning model configured to predict transitions between system states; and generating, based on an output of the machine-learning model, a plurality of candidate plausible future system states for encoding into the plurality of predicted event vectors.

In some embodiments, generating the plurality of predicted event vectors comprises: evaluating a set of deterministic rules against the system state and the historical sequence of real-time event signals; and generating a plurality of candidate future event states based on rule conditions satisfied by the system state and the historical sequence.

In some embodiments, executing the automated control action comprises: generating a control signal based on the retrieved precomputed inference output vector; and transmitting the control signal to a downstream system to cause the downstream system to perform at least one of modifying an operational parameter, initiating a transaction, or actuating a physical device.

In some embodiments, a computer-program product for reducing real-time latency via predicted event vector precomputation may comprise a non-transitory machine-readable storage medium storing computer instructions that, when executed by one or more processors, perform operations comprising: detecting, via a continuous stream of real-time input data, a plurality of real-time event signals; generating a plurality of predicted event vectors derived at least from the plurality of real-time event signals; dispatching the predicted event vectors to one or more graphics processing units (GPUs) for parallel inference processing using a neural network model, thereby producing a plurality of precomputed inference output vectors corresponding to the plurality of predicted event vectors; detecting, via the continuous stream of real-time input data, a receipt of an incoming real-time event signal, wherein the incoming real-time event signal is received after generation of the plurality of precomputed inference output vectors is initiated; transforming the incoming real-time event signal into a real-time event vector; performing a similarity search between the real-time event vector and the plurality of predicted event vectors to identify a most similar predicted event vector of the plurality of predicted event vectors relative to the real-time event vector; executing an automated control action based on a precomputed inference output vector of the plurality generated from the most similar predicted event vector.

In some embodiments, the computer instructions, when executed by the one or more processors, perform operations further comprising: identifying that the most similar predicted event vector of the plurality of predicted event vectors satisfies a similarity threshold relative to the real-time event vector; and selectively executing the automated control action using the precomputed inference output vector based on the most similar predicted event vector of the plurality of predicted event vectors satisfying the similarity threshold.

In some embodiments, executing the automated control action using the precomputed inference output vector bypasses performing inference on the real-time event vector to generate an inference output vector after the real-time event signal is received, thereby reducing total latency between receiving the precomputed inference output vector and executing the automated control action.

In some embodiments, a computer-implemented system for reducing real-time inference latency via predicted event vector precomputation, comprising: one or more processors; a memory; a computer-readable medium operably coupled to the one or more processors, the computer-readable medium having computer-readable instructions stored thereon that, when executed by the one or more processors, cause a computing device to perform operations comprising: detecting, via a continuous stream of real-time input data, a plurality of real-time event signals; generating a plurality of predicted event vectors derived at least from the plurality of real-time event signals; dispatching the predicted event vectors to one or more graphics processing units (GPUs) for parallel inference processing using a neural network model, thereby producing a plurality of precomputed inference output vectors corresponding to the plurality of predicted event vectors; detecting, via the continuous stream of real-time input data, a receipt of an incoming real-time event signal, wherein the incoming real-time event signal is received after generation of the plurality of precomputed inference output vectors is initiated; transforming the incoming real-time event signal into a real-time event vector; performing a similarity search between the real-time event vector and the plurality of predicted event vectors to identify a most similar predicted event vector of the plurality of predicted event vectors relative to the real-time event vector; executing an automated control action based on a precomputed inference output vector of the plurality generated from the most similar predicted event vector.

### BRIEF DESCRIPTION OF THE FIGURES

FIG. 1 illustrates a schematic representation of a system in accordance with one or more embodiments of the present application

FIG. 2 illustrates an example method in accordance with one or more embodiments of the present application;

FIG. 3 illustrates a schematic representation of an inference-bypass system in accordance with one or more embodiments of the present application;

FIG. 4 illustrates a feedback-back incorporating inference-bypass system in accordance with one or more embodiments of the present application;

FIG. 5 illustrates a fallback processing path in accordance with one or more embodiments of the present application; and

FIG. 6 illustrates a precomputed inference output vector replacement procedure in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1.0 System for GPU Latency-Minimized Inference

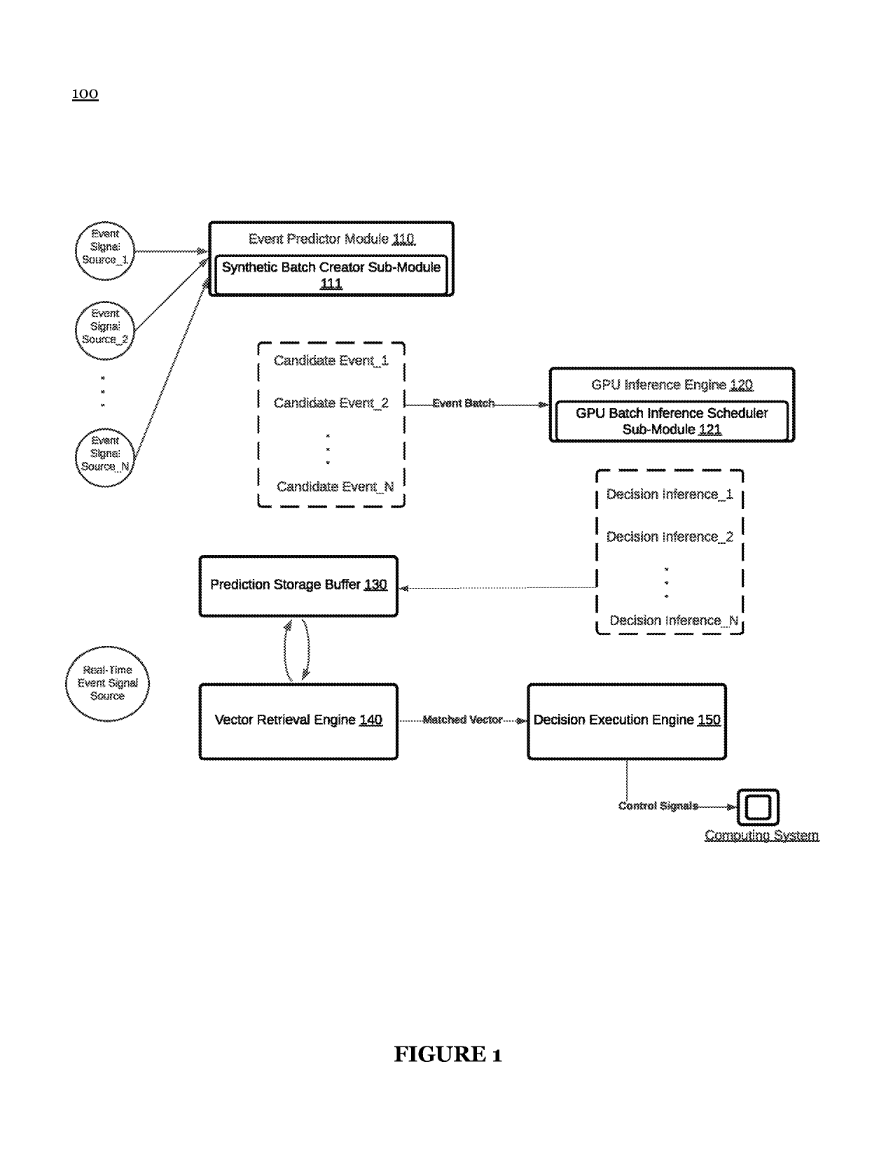

As shown in FIG. 1, a system 100 for minimizing latency in inferential computing systems for accelerating real-time decision actions in latency-sensitive computing systems and/or applications includes an event predictor module 110, a GPU inference engine 120, a prediction storage buffer 130, an approximate nearest vector retrieval engine 140, and a decision execution engine 150.

### 1.1 Event Predictor Module

The event predictor module 110 may be configured to generate a batch of predicted next events prior to the occurrence of a real-time event. The event predictor module 110 may operate upstream of the graphics processing unit (GPU) inference engine 120 and may function to construct a synthetic workload that facilitates utilization of the GPU while enabling anticipatory neural inference. It should be noted that real-time may refer to hard real-time (e.g., each event may be received within a predefined interval relative to when it is generated) or may refer to soft real-time (e.g., on average, the events may be received within a predefined interval). Further, it should be noted that the system described herein may perform processing in hard real-time (e.g., may respond or act within a predefined interval relative to when events are received) or soft real-time (e.g., may respond or act on average within a predefined interval relative to when events are received).

In one or more embodiments, the event predictor module 110 may comprise a synthetic batch creator sub-module 111. The synthetic batch creator sub-module 111 may be operable to synthesize a set of predicted input candidates including, for example, a set of plausible future events based on one or more of a current system state, a temporal history of previously observed events, or one or more probabilistic forecasting models. The synthetic batch creator sub-module 111 may employ domain-specific heuristics, machine-learned transition models such as recurrent neural networks or transformer-based sequence predictors, or rule-based generators to define a constrained event space comprising plausible upcoming event scenarios.

In some implementations, the output of the synthetic batch creator sub-module 111 may include a batch of N event candidates, where each candidate may be encoded as a fixed-length feature vector corresponding to a prospective real-world input. Each feature vector may include one or more attributes that represent system state transitions such as bid or ask price movement, changes in sensor measurements, event interarrival timing, target identifiers such as an asset or instrument identifier, or dynamic environmental variables derived from historical or real-time telemetry data. The batch of N event candidates may be generated in real-time or within a sliding temporal window, and the size N may be configurable based on available GPU resources, observed system volatility, or a predicted likelihood distribution across candidate events.

The event predictor module 110 may further interact with a contextual state manager or history buffer such that prior event sequences, user behavior, or operating environment metadata may inform or constrain batch generation of the synthetic batch creator sub-module 111. Each predicted event in the batch of N events may be timestamped or annotated with metadata such as generation confidence levels or applicable encoding parameters.

Once generated, the batch of N predicted event vectors may be provided to the GPU batch inference scheduler sub-module 121 of the GPU inference engine 120, where the batch of N predicted event vectors may be subjected to concurrent neural inference execution. The batch of N predicted events, once processed, may yield precomputed neural outputs that are subsequently stored for use by the approximate nearest vector retrieval engine 140 during the real-time event vector retrieval or event matching phase.

### 1.2 GPU Inference Engine

The GPU inference engine 120 may be configured to perform parallel computations, including parallel neural network inference computations, for a batch of predicted event vectors. The GPU inference engine 120 may function as the processing unit for generating precomputed neural responses corresponding to the batch of plausible future events generated by the event predictor module 110. In one or more embodiments, the GPU inference engine 120 may include a GPU batch inference scheduler sub-module 121, which may manage the queuing, dispatching, and coordination of neural inference tasks across available GPU execution units.

The GPU batch inference scheduler sub-module 121 may be operable to receive a batch of predicted event vectors and allocate those vectors for parallel evaluation using single instruction, multiple data (SIMD) execution. The inference scheduler 121 may employ GPU-specific programming constructs such as kernel fusion, tensor core acceleration, or cooperative thread groups to efficiently distribute the inference workload. In some embodiments, the inference scheduler 121 may dynamically adjust kernel launch parameters, batch sizes, or precision modes (e.g., FP16, INT8) based on GPU resource availability or latency optimization policies.

Each event vector received by the GPU inference engine 120 may serve as an input to a pre-trained artificial neural network model or any suitable computational model. The neural network model may comprise one or more layers configured to evaluate state transitions, pattern correlations, or contextual cues embodied in the vectorized representation of the predicted event. The artificial neural network model may be static, periodically retrained, or selected dynamically from an ensemble based on application context.

Upon execution, the GPU inference engine 120 may generate, for each event vector, a corresponding inference output. Each inference output may represent a predicted system response, recommended action, classification score, or policy evaluation corresponding to the hypothetical input. The results may be encapsulated with metadata identifying the original vector, execution context, and output validity.

In one or more embodiments, the set of inference results generated by the GPU inference engine 120 may be written to the prediction storage buffer 130, where they may be indexed for future lookup by the approximate nearest vector retrieval engine 140. The write operation may be coordinated by the GPU batch inference scheduler sub-module 121 to ensure temporal consistency, synchronization with downstream processes, or buffer overwrite protection based on prediction freshness policies.

In another embodiment, each inference output or result generated by a corresponding GPU thread may be retained within the local memory context of the corresponding GPU thread, such as a register (e.g., cache, etc.) or shared memory segment, during kernel execution. For instance, the GPU batch inference scheduler sub-module 121 may dispatch a set of predicted input vectors to parallel threads, each thread configured to evaluate a respective input vector using an artificial neural network model and temporarily store the resulting inference output in thread-local memory. In such an embodiment, the memory hierarchy of the GPU may be exploited to enable low-latency storage and retrieval, wherein inference results may be maintained in registers or shared memory accessible within the thread block. The retention of inference outputs within the GPU thread context may support immediate post-inference processing, including filtering, ranking, or proximity analysis, and may be followed by selective promotion of a subset of results to the prediction storage buffer 130 based on confidence thresholds, time sensitivity, or resource constraints. Accordingly, this implementation may reduce global memory bandwidth usage and improve throughput by enabling per-thread computation and conditional result materialization.

In some embodiments, the GPU inference engine 120 may also provide feedback signals to the event predictor module 110, such as heatmap scores or bottleneck indicators, which may inform future batch generation techniques or strategies. In such embodiments, the feedback loop may enable adaptive control over the computational budget and prediction coverage density, further optimizing latency and accuracy trade-offs in real-time environments.

Accordingly, the GPU inference engine 120 may function as a high-throughput computational backend that enables anticipatory evaluation of future states, thereby decoupling neural inference latency from the arrival of real-time events. Via the integration of the GPU inference engine 120 with the event predictor module 110 and prediction storage buffer 130, the GPU inference engine 120 may enable a low-latency, preemptively informed decision-making framework suitable for high-frequency or latency- or time-sensitive computing environments and/or applications.

### 1.3 Prediction Storage Buffer

The prediction storage buffer 130 may be configured to store a batch of precomputed neural network outputs generated by the GPU inference engine 120. The prediction storage buffer 130 may function as a fast-access memory layer (e.g., access in nanoseconds) that temporally retains inference results associated with predicted events, thereby enabling rapid retrieval when a real-time event is received and matched to a precomputed prediction.

In one or more embodiments, the prediction storage buffer 130 may be implemented using GPU-resident memory, shared on-chip cache, or high-throughput host memory that supports low-latency access and concurrent read operations. The prediction storage buffer 130 may be organized as a structured key-value store, indexed database, or vector-accessible matrix in which each entry corresponds to a predicted event vector or original text or tokens of the predicted event and its associated neural inference output.

Each stored entry within the prediction storage buffer 130 may include a representation of the original event vector (e.g., hashed or compressed encoding), the neural network output generated by the GPU inference engine 120, and any supplementary metadata required for downstream decision matching. In such embodiments, the supplementary metadata may include vector timestamps, confidence scores, model identifiers, and context descriptors.

In some embodiments, the prediction storage buffer 130 may support vector quantization or projection-based compression schemes to reduce memory footprint while preserving proximity information needed for fast nearest-neighbor search. In such embodiments, these representations may be optimized for compatibility with the vector similarity functions and/or vector similarity algorithms used by the approximate nearest vector retrieval engine 140, such as cosine distance, L2 norm, or dot product scoring.

The prediction storage buffer 130 may further support sliding-window retention policies, time-based eviction rules, or usage-driven overwrite behavior to ensure that only relevant and timely predictions are retained. For example, a prediction associated with a stale system state or outdated event context may be automatically purged or deprioritized to make space for more recent entries.

In some implementations, the prediction storage buffer 130 may also expose programmable application programming interfaces (APIs) or hooks for the approximate nearest vector retrieval engine 140 to perform accelerated lookups, index probing, or batch scoring operations. In such embodiments, the API integration may enable highly parallelizable inference recall operations at runtime, supporting sub-millisecond or even nanosecond-level response times for matched real-time inputs.

The prediction storage buffer 130, by decoupling inference computation from decision retrieval, may provide a latency-reduction mechanism that enables the system 100 to respond to live inputs without performing on-demand neural evaluations. When paired with predictive inference strategies, the predictive storage buffer 130 may transform a responsiveness of system 100 from reactive to anticipatory, offering significant performance advantages in low-latency application domains.

### 1.4 Vector Retrieval/Lookup Engine

The approximate nearest vector retrieval engine 140 may be configured to receive a real-time input event, transform the input into a vectorized representation, identify and/or retrieve the closest matching precomputed prediction stored in the prediction storage buffer 130. The approximate nearest vector retrieval engine 140 may operate as the runtime retrieval unit responsible for translating incoming event signals, in real-time, into actionable outputs with minimal computational delay.

In one or more embodiments, the approximate nearest vector retrieval engine 140 may first vectorize the incoming event using an encoding pipeline that mirrors or approximates the format used by the event predictor module 110. In such embodiments, the transformation of the real-time event signal may involve feature normalization, tokenization, embedding lookup, or dimensionality reduction, resulting in a fixed-length event vector suitable for similarity comparison.

The approximate nearest vector retrieval engine 140 may then perform a nearest-neighbor search over the contents and/or vectors of the prediction storage buffer 130. In one or more embodiments, the similarity search may be implemented using various distance metrics, including Euclidean distance, cosine similarity, dot product, Hamming distance, or learned similarity functions. In some embodiments, the approximate nearest vector retrieval engine 140 may utilize approximate nearest-neighbor techniques, such as locality-sensitive hashing (LSH), product quantization (PQ), or tree-based index structures (e.g., KD-trees, ball trees), to improve matching speed and scalability.

Accordingly, each comparison operation of the approximate nearest vector retrieval engine 140 may yield a score or distance value, and the approximate nearest vector retrieval engine 140 may be configured to return the highest-ranked result or a set of top-K results based on a configurable similarity threshold. In some implementations, if no precomputed vector in the storage buffer 130 satisfies a minimum match confidence value or falls within a predefined similarity radius, the approximate nearest vector retrieval engine 140 may trigger a fallback routine or route the input to a secondary decision module for live inference or rule-based resolution.

In one or more embodiments, to facilitate low-latency execution, the approximate nearest vector retrieval engine 140 may exploit hardware-level optimizations available in the GPU or CPU architecture, including SIMD vector instructions, shared memory loading, or cache prefetching. The retrieval engine 140 may also support parallel batch queries or pipelined processing to maintain throughput under bursty input conditions.

The approximate nearest vector retrieval engine 140, in one or more embodiments, may output an identifier of the matched precomputed event, an associated decision vector of the match precomputed event, and optionally the similarity score or ranking metadata. In such embodiments, the output of the nearest vector or the like may be forwarded to the decision execution engine 150 for action selection and downstream effect propagation.

### 1.5 Decision Execution Engine

The decision execution engine 150 may be configured to receive a matched prediction result data from the approximate nearest vector retrieval engine 140 and automatically initiate one or more corresponding system actions. The decision execution engine 150 may function as a final or near-final operational stage in the inference acceleration pipeline, translating matched precomputed neural outputs into executable downstream behavior.

In one or more embodiments, the decision execution engine 150 may be operable to retrieve a decision vector or action directive associated with a matched predicted event. The decision vector, in such embodiments, may include one or more discrete control signals, computer-executable control instructions, confidence-weighted action recommendations, or parameterized instructions that direct an automated or semi-automated behavior in an external system or integratively associated computer system. For example, in a trading context, the decision vector may trigger a control signal for automatically executing one or more computer instructions that causes a trading computer or trading server to automatically execute a bid, ask, or hold operation; in an autonomous vehicle application, the decision vector may specify control signals that, when executed, causes the autonomous vehicle to perform a steering adjustment or braking response.

The decision execution engine 150may be designed to interact with real-time control systems, messaging interfaces, transaction processors, or hardware actuators, depending on the application domain. In one or more embodiments, the decision execution engine 150 may ensure deterministic execution by automatically enforcing scheduling, prioritization, or atomicity constraints around decision invocation. In some implementations, the decision execution engine 150 may maintain an action history log or transaction buffer for auditability, rollback, or post-decision analytics.

In another implementation, in the event that the approximate nearest vector retrieval engine 140 fails to identify a satisfactory prediction match based on a similarity threshold, distance cutoff, or validity timeout—the decision execution engine 150 may be configured to invoke an automated fallback process. In such embodiments, the automated fallback process may include one or more of the following: (i) triggering a live neural inference path using the GPU engine, (ii) defaulting to rule-based heuristics or cached business logic, or (iii) suppressing the action and raising an alert or routing the event signal to a queue for manual review.

The decision execution engine 150 may further support integration with feedback mechanisms. In such embodiments, the feedback mechanisms may automatically generate a report of the success, failure, or observed effect of the executed action, enabling closed-loop system adaptation or reinforcement signal generation. In some embodiments, such feedback may be passed to the event predictor module 110 or used to adjust matching or retrieval thresholds in the approximate nearest vector retrieval engine 140.

As a technical benefit, the decision execution engine 150 may complete the real-time inference loop by enabling actions to be taken without requiring just-in-time neural computation. By acting upon pre-evaluated decisions that are optimally selected via similarity matching, the system 100 may deliver ultra-low latency response capabilities suitable for applications where timing precision, throughput, and deterministic action execution are critical.

### 2.00 Method for GPU Latency-Minimized Inference

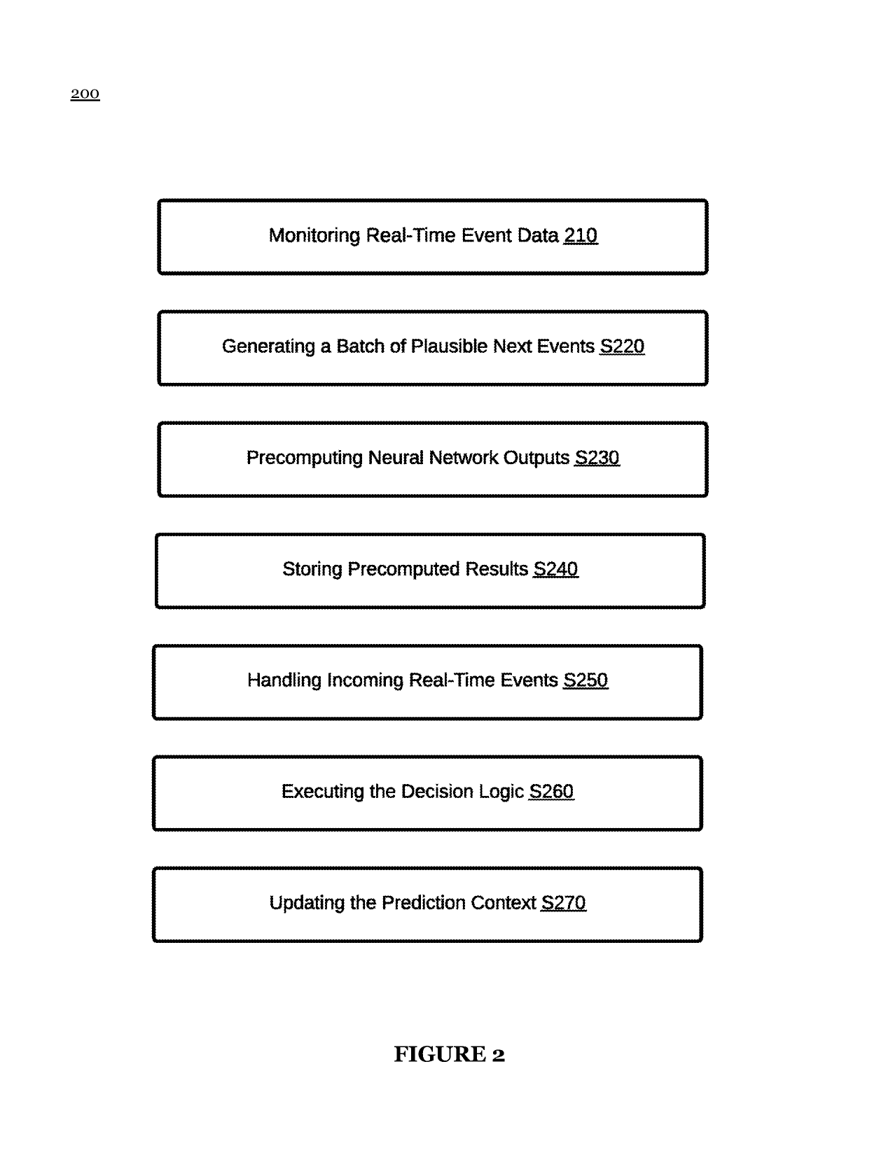

As shown in FIG. 2, a method 200 for minimizing latency in inferential computing systems for accelerating real-time decision actions in latency-sensitive computing systems and/or applications includes monitoring real-time input data S210, generating a batch of plausible next events S220, precomputing neural network outputs S230, storing precomputed results S240, handling incoming real-time events S250, executing the decision logic S260, and updating the prediction context S270.

### 2.10 Monitoring Real-Time Event Signals

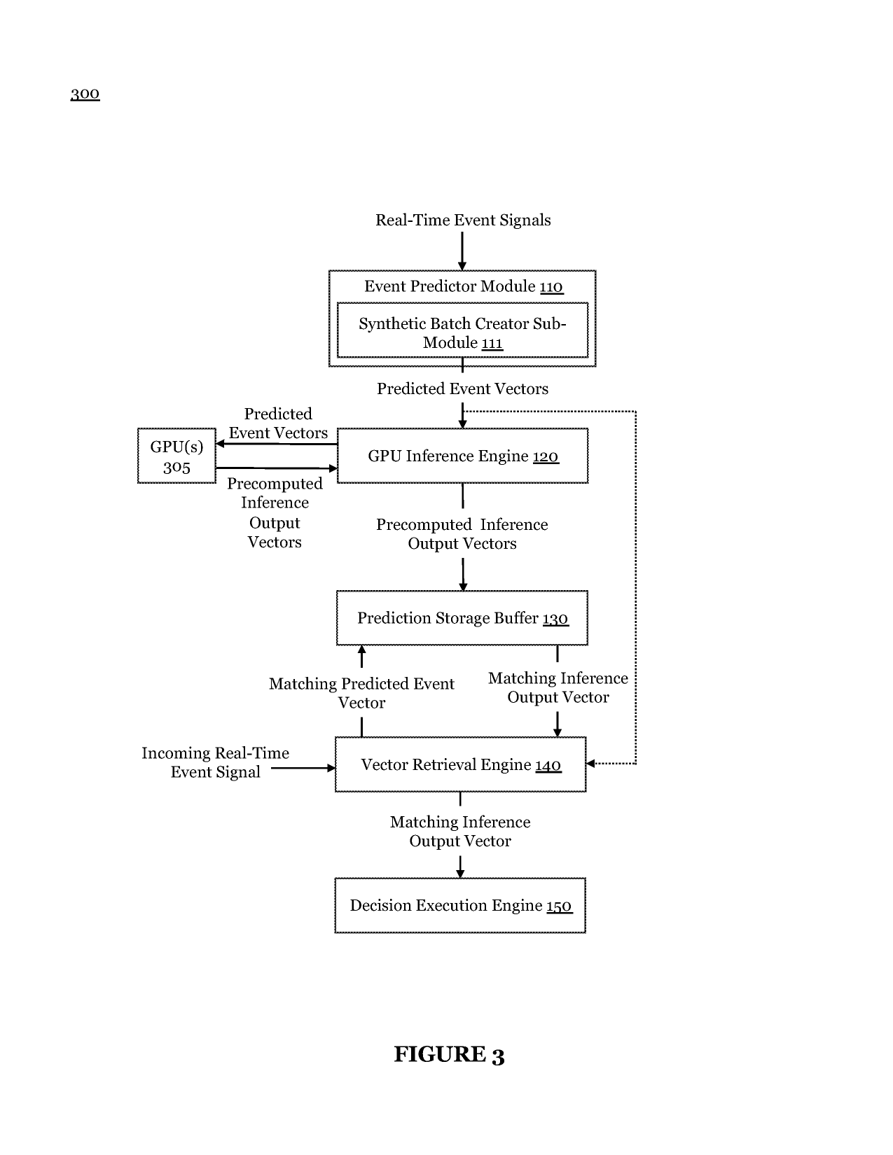

S210, which includes monitoring real-time input data, may function to monitor by a predictive decision engine or associated monitoring module, one or more real-time data streams for receipt of live event data. In one or more embodiments, the real-time input data may include time-sensitive information originating from an external data source, a sensor interface, a network feed, a transaction pipeline, or an event-driven system bus. In some embodiments, monitoring the real-time input data may include capturing, parsing, or decoding signals, messages, packets, or telemetry reflecting a current state or condition of an observed system. In a non-limiting example, as depicted in FIG. 3, event predictor module 110 may monitor for one or more real-time event signals via a continuous stream of real-time input data.

In one or more embodiments, the real-time input data may correspond to state transitions or environment changes relevant to a domain-specific task. For example, in a financial application, the real-time input data may include market microstructure updates such as bid price changes, ask spreads, last trade executions, or incoming orders. In an autonomous control application, the real-time input data may include vehicle telemetry, obstacle detection signals, or operator input transitions.

In some embodiments, S210 may function to maintain a persistent data listener or stream ingestion module that is operably coupled to the source of real-time data. In such embodiments, the ingestion module may apply preprocessing logic to normalize the data into a structured format suitable for downstream processing. The application of preprocessing logic, in or more embodiments, may include timestamp alignment, unit normalization, signal de-noising, or vector encoding.

Additionally, or alternatively, S210 may further include determining a triggering condition for initiating subsequent event prediction. In one or more embodiments, the triggering condition may be satisfied upon detection of a new data packet, a state delta exceeding a threshold, a periodic polling interval, or an external system signal. Accordingly, responsive to identifying a satisfaction of the triggering condition, S220 may be automatically initiated to generate a batch of plausible future events based on the current state.

Accordingly, at least one technical advantage of S210 includes enabling the system (e.g., system 200) implementing the method 200 to operate continuously or asynchronously with respect to incoming real-time stimuli, maintaining readiness to initiate prediction and inference processing in response to dynamic system changes. Additionally, the monitoring operation, as detailed in S210, may support high-throughput and low-latency requirements essential to time-critical environments, while also supplying the contextual input data upon which anticipatory processing in subsequent steps may rely.

### 2.20 Generating a Batch of Plausible Next Events

S220, which includes generating a batch of plausible next events, may function to synthesize, by an event prediction module (e.g., Event Predictor Module 110), a set of event candidates that represent predicted future system states or input conditions. In one or more embodiments, the generation of plausible next events may be based on a current real-time system state, one or more historical event patterns, or context-dependent forecast models. In a non-limiting example, as described with reference to FIG. 3, upon receiving the real-time event signals, synthetic batch creator sub-module 111 of event predictor module 110 may generate a set of predicted event vectors derived at least from the set of real-time event signals and may provide the set of predicted event vectors to GPU inference engine 120.

A system state may be defined as a structured representation of one or more observable and/or derived variables that collectively describe a condition of a monitored system at a given time. The system state being current may refer to it being the most recent or actively observed system state based on real-time input signals and available contextual data at a time of evaluation. The system state being current and real-time may refer to the system state being derived directly from live, continuously updated input data streams and reflecting the most up-to-date condition of the monitored system with minimal latency between observation and representation.

A future system state may correspond to a predicted evolution of the current system state resulting from a potential next event or sequence of events. Accordingly, the set of event candidates may represent predicted future system states by encoding, for each candidate, a corresponding transformation or transition from the current system state into a prospective state configuration. In such embodiments, each predicted event vector may embody both an event representation and an implied resultant system state, thereby enabling downstream inference processes to evaluate anticipated system behavior prior to actual occurrence of the corresponding real-time event.

In one or more embodiments, S220 may implement a synthetic batch creator sub-module 111 configured to define a prediction space comprising a plurality of candidate events. A prediction space may be defined as a bounded and structured set of possible future system states or event transitions that are considered plausible within a given temporal horizon based on a current system state, historical patterns, and contextual constraints. The synthetic batch creator sub-module 111 may use stochastic modeling, probabilistic sampling, domain-specific rule engines, or machine-learned transition models to generate the event candidates. For example, in a financial computing context, the generated batch may include a set of projected bid/ask transitions, trade volume changes, or correlated asset movements. In another example involving autonomous systems, the predicted events may include forward-projected telemetry conditions such as heading changes, acceleration deltas, or proximity alerts.

In one or more embodiments, S220 may include generating the plurality of candidate events using stochastic modeling and probabilistic sampling techniques implemented by the synthetic batch creator sub-module 111. In such embodiments, the synthetic batch creator sub-module 111 may construct one or more stochastic models that characterize uncertainty and variability in one or more variables of the system state based on historical event data, real-time observations, or learned model parameters. The stochastic models may define one or more probability distributions or transition dynamics governing potential future system states within the prediction space. The synthetic batch creator sub-module 111 may then perform probabilistic sampling from the one or more probability distributions to generate a plurality of candidate event vectors. Each sampled outcome may be encoded as a predicted event vector and included in the batch of plausible next events for downstream processing by the GPU inference engine 120.

In some implementations, S220 may include generating the plurality of candidate events using one or more domain-specific rule engines implemented by the synthetic batch creator sub-module 111. In such embodiments, the domain-specific rule engines may define a set of deterministic or semi-deterministic transformation rules that map a current system state to a plurality of plausible future system states within the prediction space. The transformation rules may be derived from domain knowledge, operational constraints, regulatory conditions, or empirically observed system behaviors. Each rule-derived outcome may be encoded as a predicted event vector and included in the batch of plausible next events for downstream processing by the GPU inference engine 120.

In some embodiments, S220 may include generating the plurality of candidate events using one or more machine-learned transition models implemented by the synthetic batch creator sub-module 111. In such embodiments, the machine-learned transition models may be trained to predict how a current system state is likely to evolve based on historical sequences of events and observed state transitions. The models may learn temporal dependencies, correlations, or patterns in the data, and may output one or more predicted future states or probability distributions over possible next states within the prediction space. Each generated candidate may be encoded as a predicted event vector and included in the batch of plausible next events for downstream processing by the GPU inference engine 120

In some implementations, S220 may further include determining a batch size N, where N represents the number of event candidates to be synthesized. The batch size may be statically configured or dynamically selected based on one or more of the following: GPU workload thresholds, temporal prediction horizon, historical prediction accuracy, or memory constraints associated with downstream inference processing. Each predicted event may be encoded as a fixed-length event vector, comprising numeric or categorical fields that describe a potential system state transition.

In one or more embodiments, the selection of the batch size N may directly influence a coverage of the prediction space, such that a larger batch size may enable representation of a broader or more finely sampled set of plausible future system states. In such embodiments, increasing the number of candidate event vectors may improve a likelihood that a subsequently observed real-time event corresponds to, or is sufficiently similar to, one of the predicted event vectors stored in the prediction storage buffer 130. Accordingly, the synthetic batch creator sub-module 111 may balance coverage of the prediction space with computational and memory constraints by allocating candidate event vectors across one or more regions of the prediction space based on estimated probability density, system volatility, or domain-specific relevance. In some implementations, the distribution of candidate event vectors within the prediction space may be non-uniform, such that higher-density sampling may be applied to regions associated with higher likelihood or higher impact system states, thereby improving matching accuracy and reducing fallback conditions during real-time operation.

Additionally, or alternatively, S220 may include assigning metadata to each predicted event vector. Such metadata may include confidence scores, timestamps, prediction identifiers, or vector encoding specifications. This metadata may facilitate batch coordination, vector indexing, and match accuracy within subsequent inference and decision stages.

In a preferred embodiment, S220 may function to format the batch of predicted events for GPU-compatible execution by the GPU batch inference scheduler 121, which is described in further detail with respect to S230. As such, S220 may include transforming each event vector into a structure optimized for parallel GPU inference, such as a contiguous tensor or array representation stored in memory accessible to the GPU.

At least one technical advantage of S220 includes enabling the system to anticipate future real-time conditions and prepare inference outputs before the actual event occurs. This approach may significantly reduce the latency associated with neural network evaluation in response to live inputs and may allow the system to maintain continuous utilization of compute resources between event arrivals.

### 2.30 Precomputing Neural Network or Computational Model Outputs

S230, which includes precomputing neural network or computational model outputs, may function to evaluate, by a GPU inference engine (e.g., GPU inference engine 120), a batch of predicted event vectors using a neural network model to generate a corresponding set of inference results. The precomputed inference results may be generated in parallel using GPU hardware acceleration and may represent predicted actions, classifications, or responses associated with each predicted event.

In one or more embodiments, S230 may include dispatching the batch of predicted event vectors, generated in S220, to a GPU batch inference scheduler 121. The GPU batch inference scheduler 121 may be configured to organize the vectors into a memory layout compatible with GPU kernel execution, such as a batched tensor input, and initiate parallel inference operations using GPU-optimized neural network primitives. These primitives may include forward-pass computations over one or more layers of a pre-trained neural model.

In some implementations, the neural network model evaluated during S230 may be selected based on application context, model architecture, or model versioning metadata associated with the system state. The model may include one or more of a feedforward network, a convolutional neural network, a transformer-based model, or a hybrid architecture comprising a combination of dense and recurrent layers. Each model may be configured to receive a vectorized event representation and produce an output vector that characterizes an associated system response.

Additionally, or alternatively, S230 may include embedding execution context into the inference process. For example, the GPU inference engine may augment each prediction with session-based or environment-based data before evaluation, such as active user state, time-of-day features, or market regime indicators.

In some embodiments, the GPU inference operations initiated in S230 may be carried out using single-instruction, multiple-data (SIMD) execution, tensor core acceleration, or other parallel computation frameworks supported by the GPU architecture. In such embodiments, SIMD execution may enable simultaneous evaluation of a plurality of predicted event vectors using a shared instruction stream, thereby allowing the GPU to process a large batch of hypothetical inputs in substantially the same execution window as a single inference operation. This parallel execution model may improve utilization of GPU computational resources and enable efficient precomputation of inference outputs for a dense set of candidate events within the prediction space. The GPU batch inference scheduler 121 may further track job completion, enforce inference timeouts, or recover from failed executions as part of its scheduling and coordination responsibilities.

Each inference output produced in S230 may correspond to a neural response vector associated with a predicted input. In such embodiments, the response vectors may include, for example, action selection probabilities, score rankings, continuous value predictions, or categorical classifications. S230 may further include annotating or bundling each response with metadata such as event identifiers, inference confidence scores, execution timestamps, or quality-of-service flags.

In a non-limiting example, as depicted with reference to FIG. 3, GPU inference engine 120 may dispatch received predicted event vectors to one or more GPUs 305 for parallel inference processing to produce a set of precomputed inference output vectors. In such examples, each precomputed inference output vector may correspond to a respective predicted event vector. In some examples, GPU inference engine 120 may then provide the precomputed inference output vectors to prediction storage buffer 130.

At least one technical advantage of S230 includes shifting computationally intensive neural inference from the real-time critical path into an anticipatory execution window. As a result, when a real-time event occurs, the system may retrieve and use a precomputed inference result without invoking a high-latency forward pass, thereby improving overall responsiveness, throughput, and system scalability under real-time constraints.

### 2.40 Storing Precomputed Results

S240, which includes storing precomputed results, may function to write, by a memory buffer module (e.g., prediction storage buffer 130), the output of each neural inference operation performed in S230 to a structured storage medium for later retrieval. In one or more embodiments, the prediction storage buffer 130 may be implemented using high-throughput memory, such as GPU shared memory, HBM (high bandwidth memory), or host-side DRAM configured to support concurrent read/write access by downstream components. In a non-limiting example, as described with reference to FIG. 3, prediction storage buffer 130 may receive the precomputed inference output vectors from GPU inference engine 120 and may store the precomputed inference output vectors at the prediction storage buffer 130.

In some embodiments, S240 may include serializing each inference output and associating the output with a corresponding event vector identifier, metadata, or context signature. Serialization may include organizing the inference outputs into a tabular or tensor-compatible format in which each row or record represents the prediction output for a given plausible future event. The format may include both the output vector and auxiliary metadata such as vector hash, prediction timestamp, batch identifier, or priority score.

Additionally, or alternatively, S240 may include storing each serialized output in an indexed structure, such as a hash map, KD-tree, or matrix projection, that enables fast lookup during similarity matching. The storage structure may be optimized to support efficient querying by the approximate nearest vector retrieval engine 140 using one or more similarity metrics, such as cosine similarity, Euclidean distance, or Hamming distance.

In one or more embodiments, S240 may also include managing storage constraints through buffer retention policies. For example, a retention policy may specify that only the most recent batch of predictions is retained, or that stale predictions are periodically purged based on timestamp expiration, predicted event divergence, or system load. The prediction storage buffer 130 may further support overwrite protection, ensuring that active or high-confidence predictions are retained until superseded or invalidated by new system state data.

In some cases, S240 may operate in a pipelined fashion with S230, such that inference results are streamed into the prediction storage buffer 130 as they are produced. This configuration may enable real-time systems to maintain an always-ready repository of anticipatory inference results without introducing blocking behavior or synchronization delays in the inference pipeline.

At least one technical advantage of S240 includes separating the inference computation phase from the decision-matching phase, allowing the system to treat inference results as cached lookup entries. Accordingly, the separation may reduce the real-time computational burden of the system and support ultra-low-latency retrieval of decisions in response to incoming events in S250.

### 2.50 Handling Incoming Real-Time Event Signals

S250, which includes handling incoming real-time events, may function to process a newly received event in real time and identify, using a similarity comparison, a closest matching predicted event from the batch of precomputed results stored in the prediction storage buffer 130. The operations performed in S250 may be carried out by a vector encoding module and an approximate nearest vector retrieval engine 140, and may be configured to determine, with minimal latency, whether the real-time event sufficiently matches a previously anticipated event.

In one or more embodiments, S250 may include receiving a real-time event from a live data stream, a system input queue, or an external signal. Upon receipt, the real-time event may be transformed into a structured feature vector using an encoding pipeline that applies one or more preprocessing operations. Such operations may include token extraction, field normalization, embedding lookup, or dimensionality reduction. The resulting event vector may then be formatted to match the vector representation format used by the predicted events in the prediction storage buffer 130.

Subsequently, the approximate nearest vector retrieval engine 140 may be invoked to compare the incoming event vector to the stored batch of predicted event vectors. This comparison may be performed using one or more similarity metrics, such as cosine similarity, Euclidean distance, dot product score, or other domain-specific distance measures. In some implementations, the matching engine may perform approximate nearest-neighbor search using locality-sensitive hashing (LSH), quantized vector search, or tree-based index traversal to accelerate retrieval.

S250 may further include selecting the most similar vector match from the buffer, or a top-K set of candidate matches, based on a configurable similarity threshold or ranking function. If the matching result satisfies the system-defined criteria for event equivalence, the associated precomputed inference output may be designated as the decision output for the incoming real-time event.

In one or more embodiments, S250 may include fallback logic in the case where no stored vector satisfies the similarity threshold. The fallback logic may trigger a separate processing path, such as a live forward pass through the neural network model, a rule-based inference module, or a manual operator intervention. Additionally, the unmatched event may be logged and later incorporated into future prediction batches to improve coverage.

In a non-limiting example, as described with reference to FIG. 3, event predictor module 110 may detect, via the continuous stream of real-time input data, a receipt of an incoming real-time event signal and may provide the incoming real-time event signal to vector retrieval engine 140. In some examples, the incoming real-time event signal is received after generation of the set of precomputed inference output vectors is initiated (e.g., after the generation is complete). Once vector retrieval engine 140 receives the incoming real-time event signal, vector retrieval engine 140 may transform the incoming real-time event signal into a real-time event vector and may provide the real-time event vector to prediction storage buffer 130. Prediction storage buffer 130 may perform a similarity search between the real-time event vector and the set of predicted event vectors generated by synthetic batch creator sub-module 111 to identify a most similar predicted event vector of the set of predicted event vectors relative to the real-time event vector and may provide, to the vector retrieval engine 140, a precomputed inference output vector corresponding to the most similar predicted event vector. It should be noted, alternatively, that the prediction storage buffer 130 or synthetic batch creator sub-module 111 may provide each of the set of predicted event vectors to the vector retrieval engine 140 and vector retrieval engine 140 may perform the comparison before requesting the precomputed inference output vector corresponding to the most similar predicted event vector from the prediction storage buffer 130. In either case, vector retrieval engine 140 may provide the precomputed inference output vector to the decision execution engine 150.

At least one technical advantage of S250 includes eliminating the need for real-time neural inference when the incoming event is sufficiently similar to a pre-evaluated prediction. This enables the system to respond in nanoseconds to time-sensitive conditions by substituting inference with vector lookup and retrieval, significantly improving the determinism, scalability, and performance of the predictive decision pipeline. It should be noted that substituting real-time inference with vector lookup and retrieval may enable decoupling of inference latency from decision latency. In such embodiments, neural network inference may be performed during a precomputation phase prior to receipt of a real-time event, while decision execution may occur based on retrieval of a precomputed inference output. Accordingly, computationally intensive inference operations may be removed from a latency-critical execution path, enabling low-latency decision responses in time-sensitive environments.

### 2.60 Executing the Decision Logic

S260, which includes executing the decision logic, may function to initiate, by a control module or execution engine (e.g., decision execution engine 150), one or more actions or responses based on a precomputed neural inference result selected in S250. In one or more embodiments, the execution logic may correspond to a discrete command, a parameterized instruction, a signal transmission, or an actuation directive intended for downstream systems or processes. In a non-limiting example, as described with reference to FIG. 3, decision execution engine 150 may execute an automated control action based on the retrieved precomputed inference output vector. Retrieving the precomputed inference output vector may bypass performing real-time inference on the incoming real-time event vector. Performing this bypassing may reduce inference latency (e.g., retrieving the precomputed inference output vector may take less time than performing the inference).

In some embodiments, S260 may include retrieving the precomputed output vector associated with the selected predicted event from the prediction storage buffer 130, where the output vector may encode a recommendation, classification result, or control signal. The decision execution engine 150 may interpret the structure and content of the output to determine the appropriate downstream action. For example, the output vector may include a signal to initiate a trade, issue an alert, adjust a system parameter, or activate a device control mechanism. Alternatively, the output vector may include control parameters (e.g., steering angle adjustment, braking or acceleration commands, a lane change directive), which, when executed, may cause a vehicle control system to perform a corresponding physical action. In some examples, activating the device control mechanism may involve adjusting the device control mechanism partially (e.g., adjusting it a certain specified amount rather than toggling it in between a first and second predefined position).

S260 may further include executing the action in accordance with system configuration rules, which may specify conditional branches, priority handling, resource arbitration, or timing constraints. In real-time environments, the execution engine may support atomic or deterministic operations to ensure predictable timing and correct behavior under high-throughput or concurrent conditions.

In one or more embodiments, S260 may also include recording the executed action in a log or audit buffer for tracking, rollback, or analysis. Metadata captured at execution time may include the timestamp of the action, the identity of the triggering input, the matching score from S250, and the output vector used. This logged data may later be used for reinforcement learning, debugging, or compliance auditing.

Additionally, or alternatively, S260 may include invoking a fallback or exception-handling routine if the retrieved decision vector is incomplete, invalid, or unavailable. Such fallback mechanisms may include triggering a live inference request, reverting to a default response profile, or deferring the decision to a manual or secondary system. In some implementations, fallback-triggered actions may be queued with higher priority for reprocessing or re-evaluation during the next prediction cycle.

In some examples, triggering a live inference request may include routing the incoming real-time event vector to the GPU inference engine 120 or an alternative processing unit for on-demand evaluation using a neural network model. In such embodiments, the real-time event vector may be formatted or encoded in a manner consistent with the input requirements of the neural network model, and may be dispatched by the GPU batch inference scheduler sub-module 121 for immediate execution outside of a precomputed batch. The live inference request may involve allocating compute resources, initiating a forward pass through the neural network model, and generating an inference output vector corresponding to the real-time event. In some implementations, the live inference request may be executed with elevated priority relative to background precomputation tasks to minimize response latency. The resulting inference output vector may then be provided to the decision execution engine 150 for action determination and, in some embodiments, may be incorporated into the prediction storage buffer 130 or used to update subsequent batches of predicted event vectors.

In some embodiments, reverting to a default response profile may include selecting, by the decision execution engine 150, a predefined set of rules, heuristics, or fallback control parameters when a suitable precomputed inference output vector is unavailable or when a live inference request is not performed or fails to meet latency or confidence requirements. The default response profile may be defined based on conservative operating principles, safety constraints, or baseline system behaviors appropriate for the application domain. For instance, in an autonomous system context, the default response profile may include maintaining current velocity, applying a controlled deceleration, or transitioning to a safe operating mode. The decision execution engine 150 may apply the default response profile to generate a corresponding action or control signal, and may optionally log the occurrence of the fallback condition for subsequent analysis, model retraining, or adjustment of prediction generation strategies.

In one or more embodiments, deferring the decision to a manual or secondary system may include routing, by the decision execution engine 150, the incoming real-time event or associated event vector to an external system, operator interface, or auxiliary decision module for further evaluation. In such embodiments, the deferral may be triggered when a precomputed inference output vector is unavailable, when a similarity threshold is not satisfied, or when a confidence level associated with a retrieved or computed output falls below a predefined threshold. The secondary system may include a human operator interface, a rule-based decision engine, or an alternative computational model configured to process the event and determine an appropriate response. In some implementations, the event and associated context data may be placed into a queue or message buffer for asynchronous processing, and the system may optionally suspend or delay execution of an action until a response is received.

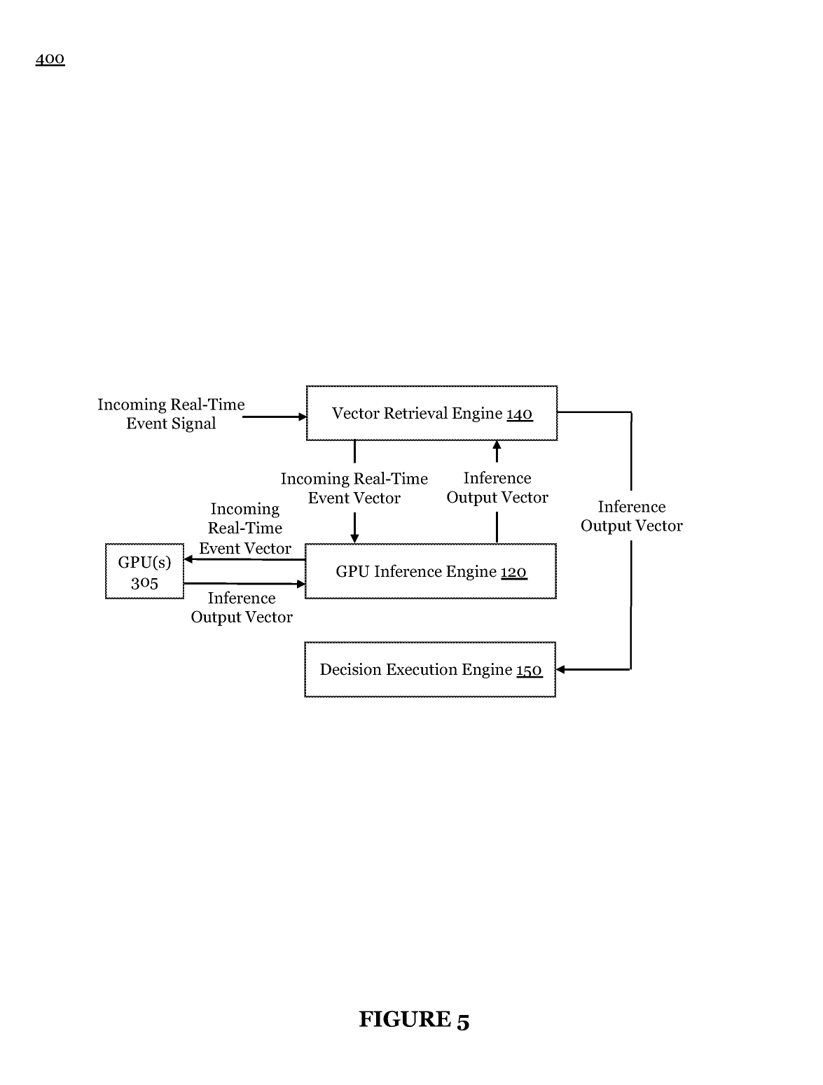

A non-limiting example of invoking the fallback logic may be depicted with reference to FIG. 5. For instance, if the incoming real-time event vector fails to match any of the predicted event vectors, the vector retrieval engine 140 may send the incoming real-time event vector for processing into an inference output vector. For instance, the vector retrieval engine 140 may provide the incoming real-time event vector to GPU inference engine 120, which may in turn dispatch the incoming real-time event vector to the one or more GPUs 305 to produce an inference output vector. The GPU inference engine 120 may then provide the inference output vector to vector retrieval engine 140, which is then provided to decision execution engine 150. It should be noted that, in cases where the incoming real-time event vector is provided to prediction storage buffer 130, prediction storage buffer 130 may provide a matching failure response to vector retrieval engine 140 to indicate to vector retrieval engine 140 that the real-time event vector has failed to match any predicted event vectors.

At least one technical advantage of S260 includes closing the inference-decision loop with ultra-low latency, allowing systems to take meaningful action in response to live inputs without incurring the delay typically associated with on-demand neural computation. As a result, the overall system may be configured to operate predictively while preserving responsiveness and control accuracy in time-sensitive domains.

### 2.70 Updating the Prediction Context

S270, which includes updating the prediction context, may function to incorporate, by a context management system, the actual real-time event into the predictive processing pipeline, and to trigger regeneration of the next batch of predicted events for subsequent inference cycles. This step may ensure that the predictive model remains current with system dynamics and responsive to unanticipated state changes.

In one or more embodiments, S270 may include logging the real-time event into a temporal event history buffer or session-specific context structure. The log entry may store a vectorized representation of the event, along with metadata such as event timestamp, origin source, matching confidence score (if available), and the identity of any executed action. The event history may serve as a basis for updating the probabilistic or model-driven assumptions used in future event generation.

Additionally, or alternatively, S270 may include triggering the Event Predictor Module (e.g., 110) to generate a refreshed batch of plausible future events based on the updated system state. The regeneration process may incorporate information such as recent event patterns, system drift indicators, model feedback, or unmodeled anomalies (e.g., out-of-distribution signals). In some cases, S270 may adapt the structure of the next batch to address observed prediction failures, include newly relevant event classes, or increase sampling resolution in high-likelihood regions of the input space.

S270 may also include managing lifecycle policies for previously stored predicted events. In one or more embodiments, the predicted events and corresponding precomputed inference outputs may be transient and short-lived, such that the prediction storage buffer 130 is continuously refreshed based on the current real-time system state. For example, stale entries in the prediction storage buffer 130 may be purged, overwritten, or deprioritized in response to newly observed events or evolving system conditions, and new entries derived from updated predicted event vectors may be generated and stored in their place (e.g., they may be prioritized for high-speed inference and matching). In such embodiments, the precomputed inference outputs may represent an ephemeral snapshot of anticipated future system states that are relevant to a current context and may not be persistently reused across extended time horizons (e.g., across multiple cycles of receiving and processing incoming real-time event signals). In systems that support dynamic model selection or context-driven policy switching, S270 may further initiate changes in prediction model selection, batch size configuration, or similarity metric parameters.

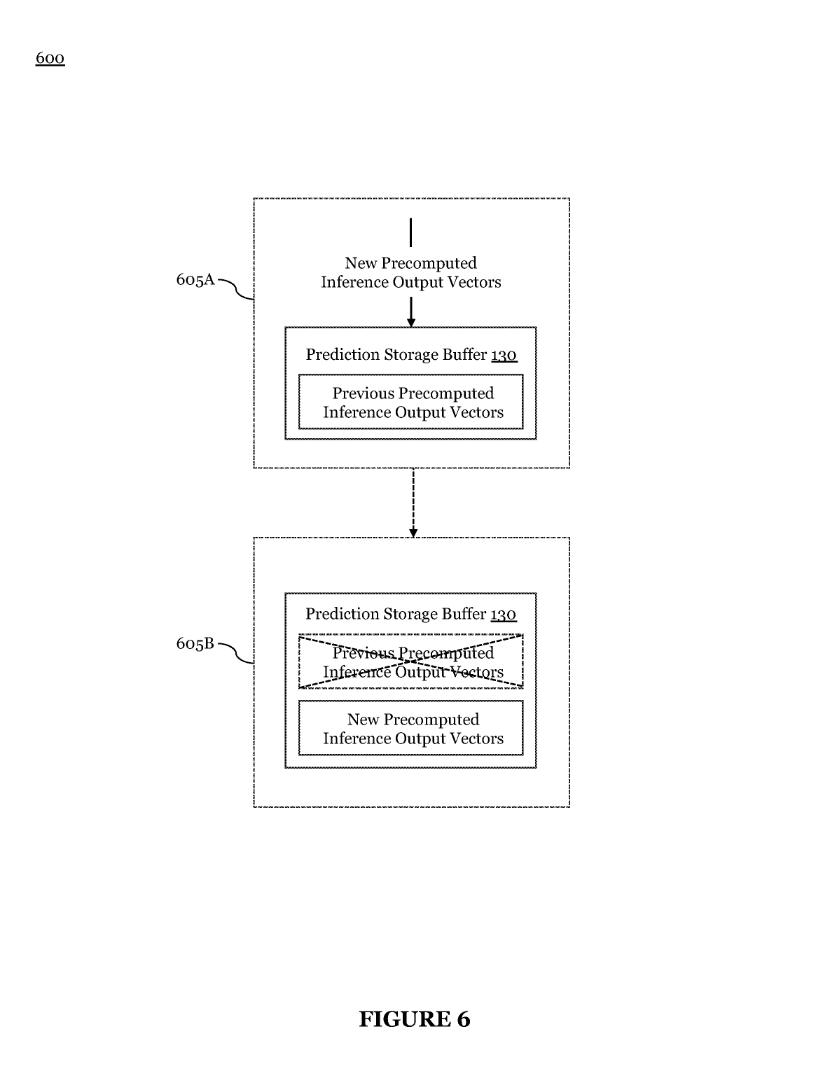

A non-limiting example of purging previously stored predicted events may be depicted with reference to FIG. 6. For instance, at an initial time 605A, prediction storage buffer 130 may store previous precomputed inference output vectors and may receive new precomputed inference output vectors. At a later time 605B, prediction storage buffer 130 may overwrite the previous precomputed inference output vectors with the new precomputed inference output vectors. Performing the overwriting in this manner may free memory within the prediction storage buffer 130 for storage of subsequently generated predicted event vectors, which may reduce the memory footprint of the prediction storage buffer 130.

In one or more embodiments, S270 may execute asynchronously relative to Steps S250 and S260 to avoid blocking downstream response execution. The update operations in S270 may be scheduled continuously, periodically, or in response to event arrival rates, model drift thresholds, or explicit system triggers.

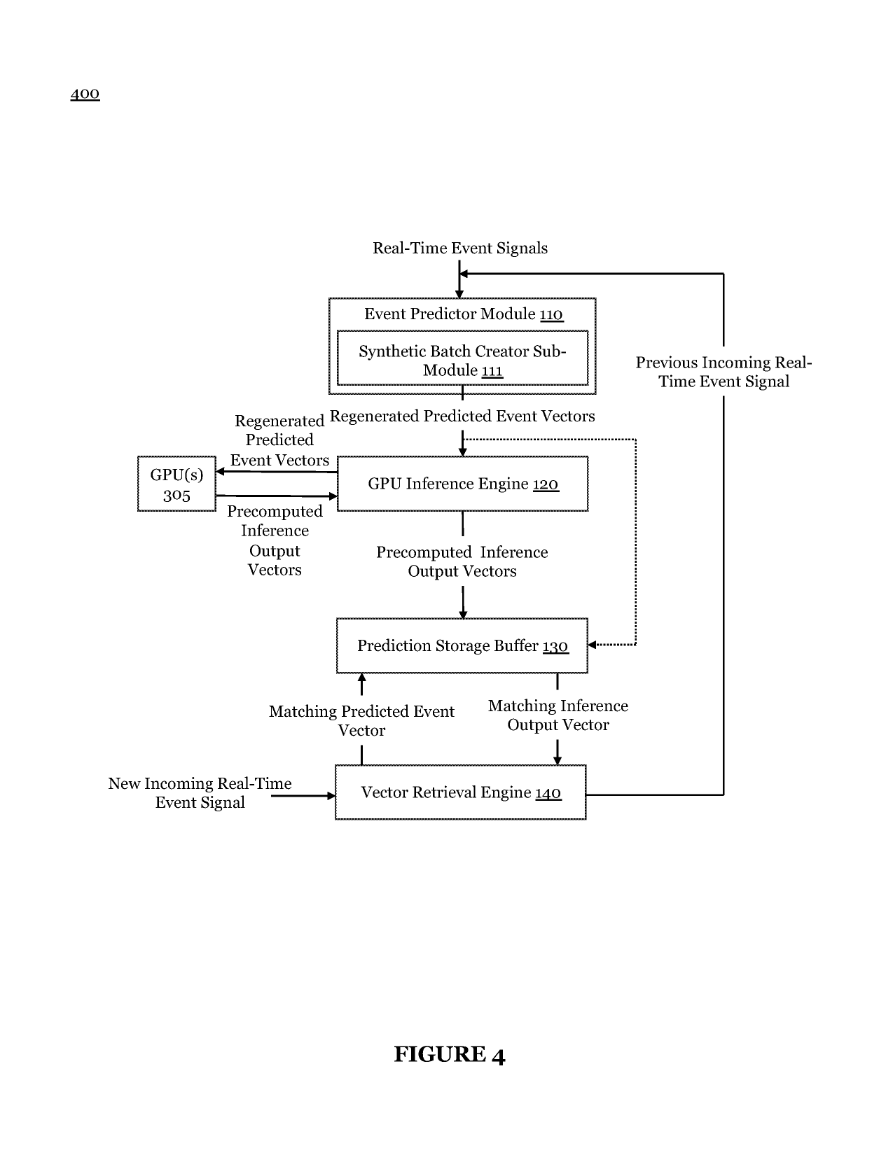

In a non-limiting example, as described with reference to FIG. 4, event predictor module 110 may incorporate the previously received incoming real-time event signal into the set of real-time event signals and synthetic batch creator sub-module 111 may regenerate the predicted event vectors based on the incorporated previous incoming real-time event signal. Corresponding precomputed inference output vectors may be generated and may be stored in prediction storage buffer 130 (e.g., replacing the previously stored precomputed inference output vectors). When a new incoming real-time event signal is received at vector retrieval engine 140, vector retrieval engine 140 may compare the associated real-time event vector with the regenerated predicted event vectors and may receive the inference output vector associated with the most similar regenerated predicted event vector. The new incoming real-time event signal may then be incorporated at the event predictor module 110 and the process may repeat.

At least one technical advantage of S270 includes enabling the predictive system to remain adaptive over time and responsive to evolving input conditions. By continuously updating the predictive context and regenerating relevant inference batches, the system may reduce false negative matches, improve action accuracy, and sustain optimal performance across long-duration operating cycles.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

Although omitted for conciseness, the preferred embodiments may include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A computer-implemented method for reducing real-time inference latency via predicted event vector precomputation, comprising:
detecting, via a continuous stream of real-time input data, a plurality of real-time event signals;
generating a plurality of predicted event vectors derived at least from the plurality of real-time event signals;
dispatching the predicted event vectors to one or more graphics processing units (GPUs) for parallel inference processing using a neural network model, thereby producing a plurality of precomputed inference output vectors corresponding to the plurality of predicted event vectors;
detecting, via the continuous stream of real-time input data, a receipt of an incoming real-time event signal, wherein the incoming real-time event signal is received after generation of the plurality of precomputed inference output vectors is initiated;
transforming the incoming real-time event signal into a real-time event vector;
performing a similarity search between the real-time event vector and the plurality of predicted event vectors to identify a most similar predicted event vector of the plurality of predicted event vectors relative to the real-time event vector;
executing an automated control action based on a precomputed inference output vector of the plurality generated from the most similar predicted event vector.

2. The computer-implemented method according to claim 1, further comprising:
identifying that the most similar predicted event vector of the plurality of predicted event vectors satisfies a similarity threshold relative to the real-time event vector; and
selectively executing the automated control action using the precomputed inference output vector based on the most similar predicted event vector of the plurality of predicted event vectors satisfying the similarity threshold.

3. The computer-implemented method according to claim 2, wherein:
executing the automated control action using the precomputed inference output vector bypasses performing inference on the real-time event vector to generate an inference output vector after the real-time event signal is received,
thereby reducing total latency between receiving the incoming real-time event signal and executing the automated control action.

4. The computer-implemented method according to claim 1, further comprising:
storing, prior to performing the similarity search, the precomputed inference output vectors at a prediction storage buffer comprising a vector-indexed data structure; and
retrieving the precomputed inference output vector from the prediction storage buffer based on identifying the most similar predicted event vector to the real-time event vector.

5. The computer-implemented method according to claim 4, further comprising:
removing, from the prediction storage buffer, the plurality of precomputed inference output vectors after identifying the most similar predicted event vector, thereby freeing the prediction storage buffer for storage of subsequently generated predicted event vectors.

6. The computer-implemented method according to claim 4, wherein:
the prediction storage buffer resides in GPU memory or high-throughput system memory.

7. The computer-implemented method according to claim 1, further comprising:
regenerating the plurality of predicted event vectors using the incoming real-time event vector via the one or more GPUs;
detecting, via the continuous stream of real-time input data and after initiating regeneration the plurality of precomputed inference output vectors, a second incoming real-time event signal; and
transforming the second incoming real-time event signal into a second real-time event vector;
performing a similarity search between the second real-time event vector and the regenerated plurality of predicted event vectors.

8. The computer-implemented method according to claim 7, further comprising:
invoking an automated fallback processing path based on each predicted event vector of the regenerated plurality failing to satisfy the predefined similarity threshold.

9. The computer-implemented method according to claim 8, wherein invoking the automated fallback processing path comprises:
dispatching the second real-time event vector to the one or more GPUs to produce an inference output vector for the second real-time event vector; and
executing a second executed control action based on the second real-time event vector.

10. The computer-implemented method according to claim 1, wherein initiating the parallel inference processing comprises:
performing the parallel inference processing during an idle execution interval between real-time event signals,
thereby enabling generation of the plurality of precomputed output vectors prior to arrival of the incoming real-time event signal.

11. The computer-implemented method according to claim 1, wherein:
the plurality of predicted event vectors are dispatched within a tensor structure to a single GPU of the one or more GPUs, and
the computer-implemented method further comprises:
executing, by the single GPU, a forward-pass evaluation of the neural network model over the plurality of predicted event vectors using single-instruction multiple-data (SIMD) parallelism.

12. The computer-implemented method according to claim 1, wherein the plurality of predicted event vectors are generated based at least in part on:
a system state current to a time at which the plurality of predicted event vectors are generated;
a historical sequence of real-time event signals comprising the plurality of received real-time event signals;
a probabilistic model defining a constrained space of predicted event vectors; or
any combination thereof.

13. The computer-implemented method according to claim 12, wherein generating the plurality of predicted event vectors comprises applying the probabilistic model to the system state and the historical sequence of real-time event signals, wherein applying the probabilistic model comprises:
estimating a probability distribution over a set of plausible future system states conditioned on the system state and the historical sequence of real-time event signals; and
sampling, based on the probability distribution, a plurality of candidate plausible future system states for encoding into the plurality of predicted event vectors.

14. The computer-implemented method according to claim 12, wherein generating the plurality of predicted event vectors comprises:
inputting the system state and the historical sequence of real-time event signals into a machine-learning model configured to predict transitions between system states; and
generating, based on an output of the machine-learning model, a plurality of candidate plausible future system states for encoding into the plurality of predicted event vectors.

15. The computer-implemented method according to claim 12, wherein generating the plurality of predicted event vectors comprises:
evaluating a set of deterministic rules against the system state and the historical sequence of real-time event signals; and
generating a plurality of candidate future event states based on rule conditions satisfied by the system state and the historical sequence.

16. The computer-implemented method according to claim 1, wherein executing the automated control action comprises:
generating a control signal based on the retrieved precomputed inference output vector; and
transmitting the control signal to a downstream system to cause the downstream system to perform at least one of modifying an operational parameter, initiating a transaction, or actuating a physical device.

17. A computer-program product for reducing real-time inference latency via predicted event vector precomputation, the computer-program product comprising a non-transitory machine-readable storage medium storing computer instructions that, when executed by one or more processors, perform operations comprising:
detecting, via a continuous stream of real-time input data, a plurality of real-time event signals;
generating a plurality of predicted event vectors derived at least from the plurality of real-time event signals;
dispatching the predicted event vectors to one or more graphics processing units (GPUs) for parallel inference processing using a neural network model, thereby producing a plurality of precomputed inference output vectors corresponding to the plurality of predicted event vectors;
detecting, via the continuous stream of real-time input data, a receipt of an incoming real-time event signal, wherein the incoming real-time event signal is received after generation of the plurality of precomputed inference output vectors is initiated;
transforming the incoming real-time event signal into a real-time event vector;
performing a similarity search between the real-time event vector and the plurality of predicted event vectors to identify a most similar predicted event vector of the plurality of predicted event vectors relative to the real-time event vector;
executing an automated control action based on a precomputed inference output vector of the plurality generated from the most similar predicted event vector.

18. The computer-program product according to claim 17, wherein the computer instructions, when executed by the one or more processors, perform operations further comprising:
identifying that the most similar predicted event vector of the plurality of predicted event vectors satisfies a similarity threshold relative to the real-time event vector; and
selectively executing the automated control action using the precomputed inference output vector based on the most similar predicted event vector of the plurality of predicted event vectors satisfying the similarity threshold.

19. The computer-program product according to claim 18, wherein:
executing the automated control action using the precomputed inference output vector bypasses performing inference on the real-time event vector to generate an inference output vector after the real-time event signal is received,
thereby reducing total latency between receiving the precomputed inference output vector and executing the automated control action.

20. A computer-implemented system for reducing real-time inference latency via predicted event vector precomputation, comprising:
one or more processors;
a memory;
a computer-readable medium operably coupled to the one or more processors, the computer-readable medium having computer-readable instructions stored thereon that, when executed by the one or more processors, cause a computing device to perform operations comprising:
detecting, via a continuous stream of real-time input data, a plurality of real-time event signals;
generating a plurality of predicted event vectors derived at least from the plurality of real-time event signals;
dispatching the predicted event vectors to one or more graphics processing units (GPUs) for parallel inference processing using a neural network model, thereby producing a plurality of precomputed inference output vectors corresponding to the plurality of predicted event vectors;
detecting, via the continuous stream of real-time input data, a receipt of an incoming real-time event signal, wherein the incoming real-time event signal is received after generation of the plurality of precomputed inference output vectors is initiated;
transforming the incoming real-time event signal into a real-time event vector;
performing a similarity search between the real-time event vector and the plurality of predicted event vectors to identify a most similar predicted event vector of the plurality of predicted event vectors relative to the real-time event vector;
executing an automated control action based on a precomputed inference output vector of the plurality generated from the most similar predicted event vector.
